(19) United States
(12) Patent Application Publication
(10) Pub. No.: US 2007/0172055 A1
(43) Pub. Date: Jul. 26, 2007

(54) Apparatus and method for distorting digital contents and recovering the distorted contents

(76) Inventor: Bea Su Jo, Seoul (KR)

Correspondence Address: PARK LAW FIRM, 3255 WILSHIRE BLVD, SUITE 1110, LOS ANGELES, CA, 90010, US

(21) Appl. No.: 10/582,547

(22) PCT Filed: Dec. 11, 2004
(86) PCT No.: PCT/KR04/03261

§ 371 Date: Jun. 9, 2006

(30) Foreign Application Priority Data
Dec. 11, 2003 (KR) 10-2003-0090322
Dec. 11, 2004 (KR) 10-2004-0104544

(51) Int. Cl. H04N 7/167

(52) U.S. Cl. 380/210

(57) ABSTRACT

A distorted contents generating apparatus is provided. The distorted contents generating apparatus includes: an initial value generation unit for generating an initial value used to generate a random number for a distorting filter; a random number generation unit for generating a random number for the distorting based on the initial value transmitted from the initial value generation unit; a filter generation unit for generating a distorting filter based on the random number; a data filtering unit for distorting an original contents by filtering the original contents with the distorting filter; an encoding unit for encoding the distorted contents output from the data filtering unit; a signal insertion unit for encrypting the initial value information generated by the initial value generation unit and inserting the encrypted filter initial value into the distorted contents; and an image correction unit for inserting image correction information into the encoded distorted contents transmitted from the encoding unit.

### TECHNICAL FIELD

The present invention relates to a method of protecting digital contents, and more particularly, to a distorted contents generating and recovering method and apparatus capable of preventing the digital contents from being illegally copied and distributed.

### BACKGROUND ART

As technology for computers and networks has been developed, various types of the digital contents can be easily accessed. In addition, digital contents markets have increased. However, copyrights to the digital contents have not completely protected, so that the digital contents business cannot be activated.

Recently, various types of digital contents protection techniques including a DRM (digital right management) scheme and a digital watermarking scheme have been proposed.

According to the DRM scheme, only the authorized user can use the digital contents in order to protect the copyright to the digital contents. In the DRM scheme, the digital contents are converted in an encrypted packaged format, so that unauthorized user cannot use the digital contents. Therefore, the associated authorization procedure and an additional payment procedure are required before the user uses the digital contents.

For example, in case of a downloading type, the user requests for the digital contents, and then a contents provider allows a PC of the user to download the digital contents. When the user tries to execute the digital contents, the payment procedure is activated. After the payment is completed, a license is issued to the user through a payment gateway from a clearing house server (a license server). If the license is issued, the encrypted digital contents can be decrypted, so that the user can use the digital contents. However, these procedures are so complicated that the DRM scheme cannot be adapted to the various types of distribution paths.

In addition, according to encryption techniques used for the DRM scheme, data of the digital contents is scrambled and only the user having an encryption key can decrypt the scrambled data. However, once the encryption key is hacked, it is impossible to prevent the digital contents from be illegally distributed and copied.

In addition, the payment procedure and other complicated procedures in the DRM scheme displease the user. In addition, the contents provider has to pay large costs for implementing a system associated with the payment procedure and other complicated procedures. In addition, the DRM scheme cannot be adapted to conventional analog system.

On the other hand, in the digital watermarking scheme, specific patterns for identifying the copyright are inserted into the digital contents including image, audio, and video data. Here, the specific patterns are not recognized with naked eyes of the user. By using the digital watermarking scheme, the copyright to the digital contents can be systematically protected, so that demands for the scheme have increased.

In general, the watermarks are used to identify a copyright to the digital contents after the digital contents are illegally used. In addition, it is almost impossible for the copyrighter to monitor illegal uses of a large number of the digital contents day by day. Therefore, the watermarking scheme cannot efficiently protect the copyright. In addition, various watermarking schemes are not standardized even though the associated techniques have been increasingly developed. The watermarking techniques cannot satisfy requests of the users. Particularly, it is difficult to detect watermarks from the digital contents during the re-sizing or extraction processes.

Therefore, there are needs for a new digital contents protection technique to complement the conventional digital contents protection techniques.

### SUMMARY OF THE INVENTION

In order to solve the aforementioned problems, the present invention is to provide a distorted contents generating and recovering method and apparatus capable of improving accessibility of a user and providing the digital contents via various types of distribution paths without infringement of a copyright to the digital contents.

In addition, the present invention is to provide a distorted contents generating and recovering method and apparatus capable of completely preventing the digital contents from being illegally recovered by distorting a portion of the digital contents in advance before the digital contents is distributed.

In addition, the present invention is to provide a distorted contents generating and recovering method and apparatus capable of limiting recovering and reproducing times for the digital contents by gradually and automatically removing recovering filter data.

According to an aspect of the present invention, there is provided a distorted contents generating apparatus comprising: an initial value generation unit for generating an initial value used to generate a random number for a distorting filter; a random number generation unit for generating a random number for the distorting based on the initial value transmitted from the initial value generation unit; a filter generation unit for generating a distorting filter based on the random number; a data filtering unit for distorting an original contents by filtering the original contents with the distorting filter; an encoding unit for encoding the distorted contents output from the data filtering unit; a signal insertion unit for encrypting the initial value information generated by the initial value generation unit and inserting the encrypted filter initial value into the distorted contents; and an image correction unit for inserting image correction information into the encoded distorted contents transmitted from the encoding unit.

According to another aspect of the present invention, there is provided a distorted contents recovering apparatus comprising: a decoding unit for decompressing and decoding a distorted contents; a contents analyzing unit for extracting recovering information for the distorted contents; a signal extraction unit for extracting an encrypted filter initial value and image correction information from the decompressed distorted contents; and a contents recovering unit for generating a recovering filter based on the filter initial value and recovering contents from the distorted contents by using the recovering filter.

According to still another aspect of the present invention, there is provided a distorted contents generating method comprising steps of: generating an initial value used to generate a random number for a distorting filter; generating a distorting filter based on the generated initial value; distorting an original contents with the distorting filter; encrypting information on the distorting filter; generating correction information on the distorted contents; and generating the distorted contents by packaging the generated distorted contents, the information on the distorting filter, and the distortion correction information.

According to further still another aspect of the present invention, there is provided a distorted contents generating method comprising steps of: generating an initial value used to generate a random number for a distorting filter; generating a distorting filter based on the generated initial value; distorting an original contents with the distorting filter; encrypting information on the distorting filter; generating correction information on the distorted contents; and generating the distorted contents by packaging the generated distorted contents, the information on the distorting filter, and the distortion correction information.

In the aspects of the present invention, the original contents such as music and image contents is distorted by using the distorting filter, and the distorted contents is transmitted to the user in order to prevent the digital contents from being illegally copied and distributed. A receiving party receives the distorted contents and recovers the distorted contents by using a predetermined recovering filter.

The distorting filer is characterized by the random value generated based on the initial value. The initial value used for recovering the distorted contents is encrypted and transmitted together with the distorted contents. In order to recover the distorted contents, the user has to utilize an encryption key for decrypting the encrypted initial value and generates a recovering filter based on the initial value.

In addition, the recovering filter information used to recover the distorted contents is transmitted together with the distorted contents. In the digital contents recovering system according to the present invention, the recovering filter information transmitted to a client or user automatically changes during a recovering operation, so that it is possible to completely prevent the digital contents from being illegally copied and distributed.

### BRIEF DESCRIPTION OF THE DRAWING

FIG. 1 is a view showing a distorted contents generating and recovering system according to the present invention;

FIG. 2 is a view showing distorted contents generating and recovering apparatuses according to the present invention;

FIG. 3 is a block diagram showing a detailed construction of a distorted contents generating apparatus according to an embodiment of the present invention;

FIG. 4 is a block diagram showing a detailed construction of a distorted contents recovering apparatus according to an embodiment of the present invention;

FIG. 5 is a view showing data flow in distorted contents generating and recovering apparatuses according to an embodiment of the present invention;

FIG. 6 is a flowchart of a distorted contents generating procedure according to an embodiment of the present invention;

FIG. 7 is a flowchart of a distorted contents recovering procedure according to an embodiment of the present invention;

FIG. 8 is a view showing a structure of packaged distorted contents according to an embodiment of the present invention;

FIG. 9 is a view showing a method of distorting an original image according to an embodiment of the present invention;

FIG. 10 is a view showing a distorted contents generating method according to an embodiment of the present invention;

FIG. 11 is a view showing a distorted moving picture contents generating and recovering system according to the present invention;

FIG. 12 is a view showing a distorted sound contents generating and recovering system according to the present invention; and

FIG. 13 is a view showing a recovering key exchange procedure used for the distorted sound contents generating and recovering system according to the present invention.

### BEST MODE FOR CARRYING OUT THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

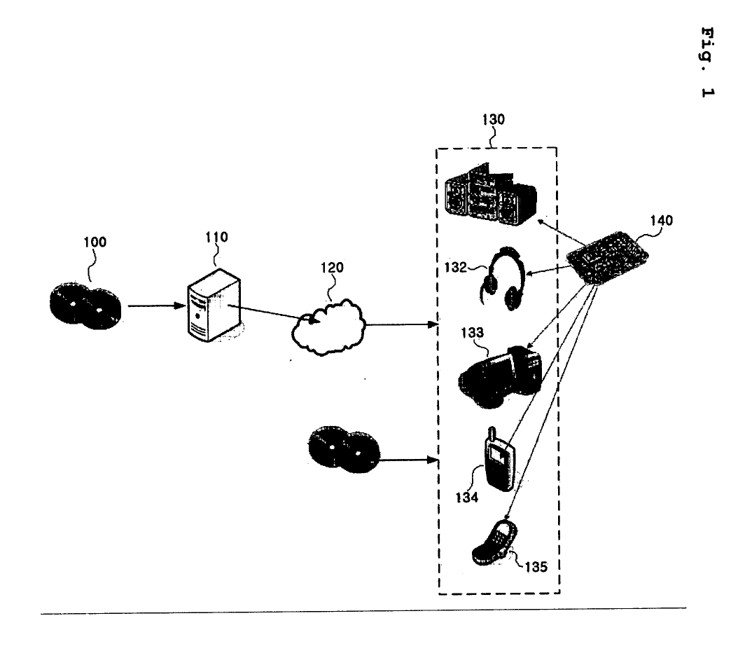

FIG. 1 is a view showing a distorted contents generating and recovering system according to the present invention.

Referring to FIG. 1, the distorted contents generating and recovering system includes a distorted contents generating apparatus 110 for distorting a digital contents 100 and transmitting the distorted contents via a network 120 and a distorted contents recovering apparatus 140 for recovering an original contents from the transmitted distorted contents 100.

The distorted contents recovering apparatus 140 may be implemented in a software and hardware manner. The distorted contents recovering apparatus 140 is embedded in or separated from a digital contents reproducing device 130. The digital contents reproducing device 130, for example, includes audio players 131, headphones 132, PCs and TVs 133, smart phones 134, and mobile phones 135.

The digital contents 100 is distorted by the distorted contents generating apparatus 110 and transmitted to a client via the network 120. The digital contents reproducing device 130 of the client reproduces the transmitted distorted contents. In a case where the digital contents reproducing device 130 is not an authenticated device, the contents is reproduced in a distorted format. In this case, by using the distorted contents recovering apparatus 140 embedded in or separated from the digital contents reproducing device 130, an original contents can be recovered from the distorted contents.

On the other hand, the distorted contents generating apparatus 110 distorts the original contents with a predetermined distorting filter described below. If the original contents is an analog contents, the original analog contents is converted into a digital contents before the original contents is distorted.

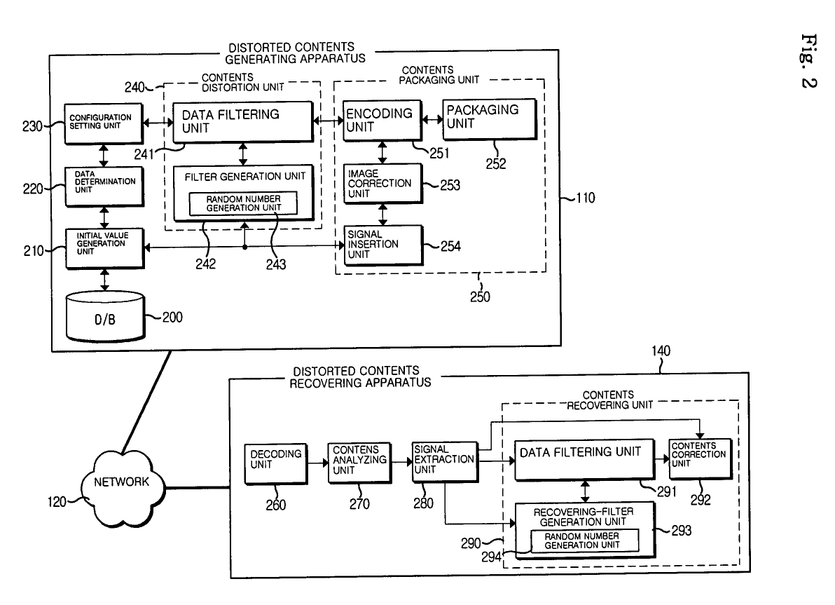

Now, the distorted contents generating and recovering apparatuses 110 and 140 will be described in detail with reference to FIGS. 2 to 4.

FIG. 2 is a view showing the distorted contents generating and recovering apparatuses 110 and 140 according to the present invention.

Referring to FIG. 2, the distorted contents generated by the distorted contents generating apparatus 110 is transmitted to the client via the network 120, as shown in FIG. 1. The client has the distorted contents recovering apparatus 140 for recovering the original contents from the distorted contents, so that the original contents can be reproduced.

The distorted contents generating apparatus 110 includes database 200, an initial value generation unit 210, a data determination unit 220, a configuration setting unit 230, a contents distortion unit 240, and a contents packaging unit 250. The distorted contents recovering apparatus 140 includes a decoding unit 260, a contents analyzing unit 270, a signal extraction unit 280, and a contents recovering unit 290.

The database 200 stores analog or digital contents. The database 200 may further store filter information which is used to generate the distorting filter. The initial value generation unit 210 generates a distorting filter initial value, an encryption information initial value, and a correction information initial value.

The determination unit 220 determines contents information of the original contents in order to effectively distort the original contents. The contents information includes type and size of the original contents. For example, in a case where the original contents is a video contents, the data determination unit 220 determines a screen size, the number of frames, a reproducing time, and so on. In a case where the original contents is an audio contents, the determination unit 220 determines data amount per unit time, a reproducing time, and so on.

Preferably, the data determination unit 220 may further comprises a data format determination unit (not shown) for analyzing a data format of the original contents and a codex unit (not shown) for decompressing the original contents if the original contents is of a compressed file format.

The configuration setting unit 230 determines configuration setting values for the distorting filter based on the contents information output from the data determination unit 220. The configuration setting values are associated with a distortion degree of a distorted contents. The configuration setting values include data amount of distorted contents, distorting range, and information on partitions of frames of the contents. More specifically, the configuration setting values includes the number of partitions per frame and the number of random-number-applied partitions.

In addition, the configuration setting values may further include information on at least one of the number of partitions per frame of contents, the number of partitions to which the random number for the distorting filter is applied, an occupation rate of the random number for the distorting filter applied to the partitions of each of the frames of the contents, the number of distorting filters applied to streams of the digital contents, and a stream range to which the distorting filter is applied.

The configuration setting unit 230 may provide the distorting filter initial value output from the initial value generation unit 210 in accordance with the contents information. In addition, the configuration setting unit 230 may provide a size of the random number, a size of the distorting filter, and so on.

The contents distortion unit 240 comprises a data filtering unit 241 and a filter generation unit 242. Preferably, the filter generation unit 242 comprises a random number generation unit 243. The random number generation unit 243 generates the random number based on the distorting filter initial value output from the initial value generation unit 210. The filter generation unit 242 generates the distorting filter based on the random number.

The data filtering unit 241 distorts the original contents by filtering the original contents with the distorting filter. The distorted contents output from the contents distortion unit 240 is transmitted to the contents packaging unit 250.

The contents packaging unit 250 generates a package of the distorted contents and additional information. The contents packaging unit 250 may comprises an encoding unit 251, a packaging unit 252, an image correction unit 253, and a signal insertion unit 254.

The encoding unit 251 compresses or encodes the distorted contents in accordance with a predetermined codex for digital data. If the distorted contents is a media file, the distorted contents may be encoded in a predetermined format including AVI (Audio Video Interactive), ASF (Advanced Streaming Format), WMV (Window Media Video), WMA (Window Media Audio), MOV, MPEGX (Moving picture contents Experts Group-X) such as MPEG-1, MPEG-2, and MPEG-3, MPEG-4, and RA (Real Audio) formats.

The image correction unit 253 inserts image correction information into the distorted contents in order to facilitate recovering the original contents from the distorted contents. The image correction unit 253 repeats the image correction information inserting process until the correction information becomes allowable correction information.

The signal insertion unit 254 encrypts the distorting filter initial value and inserts the encrypted filter initial value into the image signal to which the image correction information is inserted by the image correction unit 253.

The packaging unit 252 generates a package of multiple image signals to which the image correction information and the distorting filter initial value are inserted.

On the other hand, the distorted contents recovering apparatus 140 has a function of recovering the original contents from the distorted contents. The distorted contents recovering apparatus 140 includes the decoding unit 260, the contents analyzing unit 270, the signal extraction unit 280, and the contents recovering unit 290.

The contents recovering unit 290 comprises a data filtering unit 291, a contents correction unit 292, and a recovering filter generation unit 293. The recovering filter generation unit 293 comprises a random number generation unit 294 for generating a random number used to generate a recovering filter.

The decoding unit 260 decodes the distorted contents in accordance with a predetermined decoding scheme. The predetermined decoding scheme depends on an encoding scheme of the encoding unit 251 in the distorted contents generating apparatus 110. In the decoding unit 260, the encrypted filter information and the image correction information are decompressed as a portion of the compressed contents, so that the distorted contents compressed in accordance with any compressing algorithm can be easily recovered. Therefore, a copyright to the original contents can be completely protected from any conventional digital contents players.

The contents analyzing unit 270 detects the encrypted filter information and the image correction information to extract basic image recovering information such as size of filter. The signal extraction unit 280 extracts the encrypted filter information and the image correction information from the decompressed image signal.

The image correction information and the encrypted filter information extracted by the signal extraction unit 280 are input to the contents correction unit 292 and the recovering filter generation unit 293. The distorted contents from which the image correction information and the encrypted filter information are removed is transmitted to the data filtering unit 291.

The recovering filter generation unit 293 decrypts the encrypted filter information which is used as an initial value for generating filter and random number. The random number generation unit 294 generates filter information value for recovering contents from the initial value.

The recovering filter generation unit 293 generates the recovering filter used to recover the contents by using the filter information value generated by the random number generation unit 294 and the filter generation initial value generated by decrypting the encrypted filter information.

The filter information generated by the recovering filter generation unit 293 is transmitted to the data filtering unit 291. The data filtering unit 291 recovers the distorted contents by using the transmitted filter information. The recovering filter has an inverse functional relation with the distorting filter used to distort the contents.

The contents recovered by the recovering filter of the data filtering unit 291 are transmitted to the contents correction unit 292. The contents correction unit 292 corrects some portions of the recovered contents by using the correction information transmitted from the signal extraction unit 280, so that completely recovered image can be output.

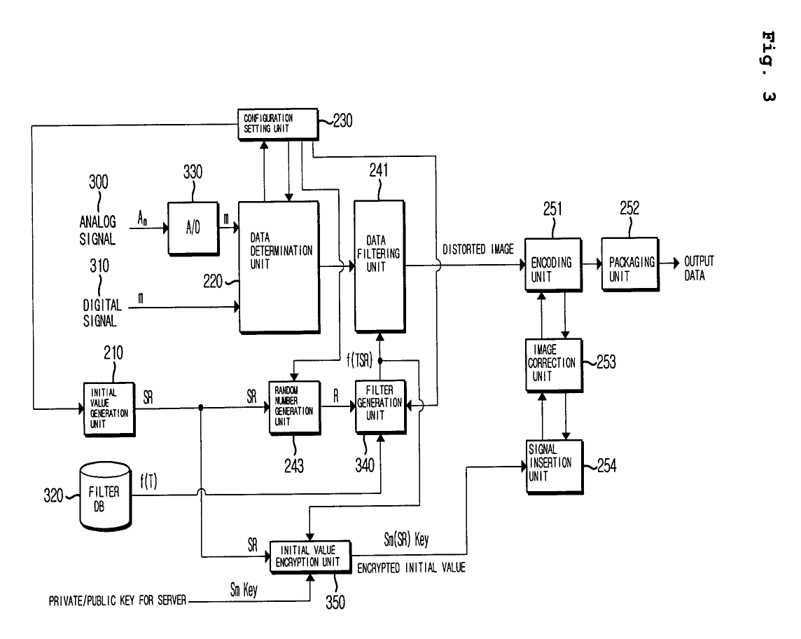

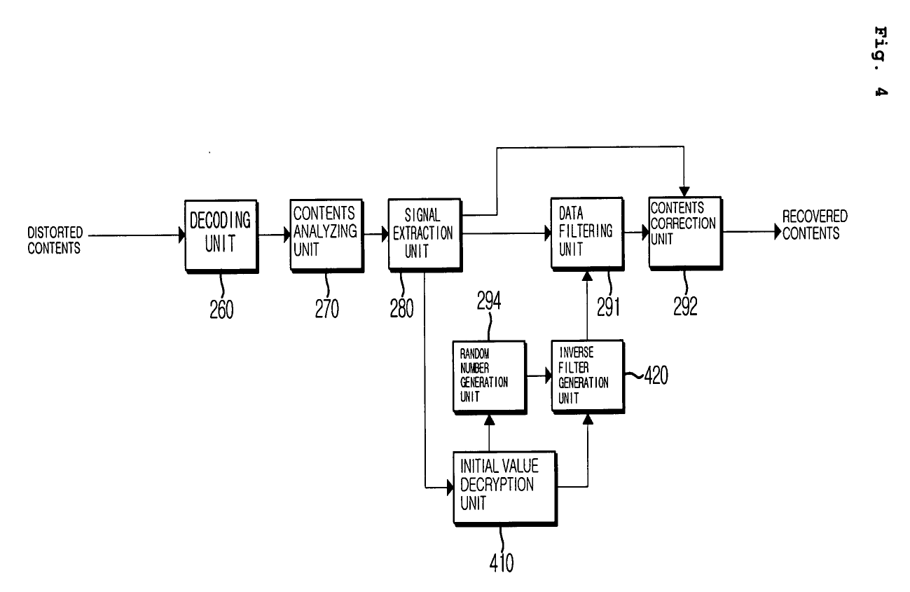

Now, embodiments of the distorted contents generating apparatus 110 and the distorted contents recovering apparatus 140 will be described in detail with reference to FIGS. 3 and 4.

FIG. 3 is a block diagram showing a detailed construction of a distorted contents generating apparatus according to an embodiment of the present invention.

Referring to FIG. 3, the distorted contents generating apparatus 110 according to the embodiment of the present invention comprises an analog-to-digital conversion unit 330, a configuration setting unit 230, a data determination unit 220, a data filtering unit 241, initial value generation unit 210, a random number generation unit 243, a filter generation unit 340, a filter information database 320, an initial value encryption unit 350, an encoding unit 251, an image correction unit 253, a signal insertion unit 254, and packaging unit 252.

Contents information is input to the data determination unit 220. In a case where the contents information is an analog signal Am, the analog signal Am is converted to a digital signal m by the Analog-to-digital conversion unit 330 before the contents information is input to the data determination unit 220. In a case where the contents information is a digital signal m, the contents information is input to the data determination unit 220 without any conversion.

The data determination unit 220 determines information including a format of the input digital contents and transmits the information to the configuration setting unit 230 as shown in FIG. 2. For example, in a case where the digital contents is a video contents, the information determined by the data determination unit 220 includes a screen size, the number of frames, s reproducing time; and in a case where the digital contents is an audio contents, the information includes a data amount per unit time and a reproducing time.

The information on the contents determined by the data determination unit 220 is transmitted to the configuration setting unit 230. The configuration setting unit 230 determines configuration setting values based on the information on the contents determined by the data determination unit 220 and provides the configuration setting values to the initial value generation unit 210, the random number generation unit 243, and the filter generation unit 340. The configuration setting values include a data amount of distorted contents, distorting range, and partitions of frames of the contents. More specifically, the configuration setting values includes the number of partitions per frame and the number of random-number-applied partitions.

The configuration setting unit 230 transmits initialization information, random number size information, and filter size information to the initial value generation unit 210, the generating apparatus, and the filter generation unit 340, respectively.

The initial value generation unit 210 generates an initial value SR based on the initialization information (for example, a field adjusting value) transmitted from the initial value generation unit 210. The initial value SR is used to initialize the random number generation unit 243. All the encryption and correction information are based on the initial value SR.

The initial value SR generated by the initial value generation unit 210 is transmitted to the random number generation unit 243. The random number generation unit 243 generates the random number R based on the initial value SR transmitted from the initial value generation unit 210 and the random number size setting value transmitted from the configuration setting unit 230. The random number R is used to generate the distorting filter.

The filter generation unit 340 generates the distorting filter based on various filter information transmitted from the filter information database 320 and the random number R transmitted from the random number generation unit 243. The filter information stored in the filter information database 320 denotes information used to distort the contents.

The data filtering unit 241 receives the contents information from the data determination unit 220 and filters the contents information with the distorting filter generated by the filter generation unit 340, so that the contents can be distorted.

The initial value information is transmitted to the initial value encryption unit 350. The initial value encryption unit 350 encrypts the initial value by using a private/public key Sm Key for a server. The private/public key Sm Key denotes a private/public key used for an encryption algorithm for encrypting the initial value. The encrypted initial value Sm(SR) Key is transmitted to the signal insertion unit 254. The signal insertion unit 254 combines the encrypted initial value Sm(SR) Key with the distorted contents. The encrypted initial value Sm(SR) Key becomes a master key which is transmitted to a reproducing client via a secret communication.

The filtered distorted contents is transmitted to the encoding unit 251. The encoding unit 251 compresses or encodes the filtered distorted contents in accordance with a predetermined codex as described above. IN addition, the encoding unit 251 inserts header information to the compressed or encoded distorted contents.

The an image correction unit 253 inserts image correction information to the distorted contents in order to facilitate recovering the original contents from the compressed distorted image. In addition, the image correction unit 253 repeatedly performs the correction information generation process until the correction information is an allowable image correction value.

The signal insertion unit 254 inserts the encrypted initial value Sm(SR) Key (received from the initial value encryption unit 350) to the image signal to which the correction information is inserted. The signal insertion unit 254 transmits the distorted contents (to which the encrypted initial value Sm(SR) Key is inserted) to the encoding unit 251 via the image correction unit 253. The encoding unit 251 transmits the distorted contents (to which the correction information and the encrypted initial value Sm(SR) Key are inserted) to the packaging unit 252.

The packaging unit 252 generates the packaged distorted contents by packaging the distorted contents (to which the correction information and the encrypted initial value Sm(SR) Key are inserted). The packaged distorted contents is provided to the clients. Only the clients having a recovering function can reproduce the packaged distorted contents. General clients having no recovering function cannot reproduce the packaged distorted contents.

Now, an embodiment of the distorted contents recovering apparatus 140 for recovering the distorted contents generated by the distorted contents generating apparatus 110 of FIG. 3 will be described with reference to FIG. 4.

FIG. 4 is a block diagram showing a detailed construction of a distorted contents recovering apparatus according to an embodiment of the present invention.

Referring to FIG. 4, the distorted contents recovering apparatus 140 according to the present invention comprises a decoding unit 260, a contents analyzing unit 270, a signal extraction unit 280, a data filtering unit 291, a contents correction unit 292, a random number generation unit 294, an initial value decryption unit 410, and inverse filter generation unit 420.

The distorted contents input to the distorted contents recovering apparatus 140 is decompressed or decoded by the decoding unit 260. The decoding scheme used for the decoding unit 260 depends on an encoding scheme used for the encoding unit 251 of the distorted contents generating apparatus 110. Since in the decoding unit 260 the encrypted filter information and the correction information are treated as a portion of the compressed digital contents, the recovering process can be effectively performed on the digital contents compressed by using any types of compression algorithms. In addition, the copyright to the contents can be completely protected without replacement or exchange of the conventional contents players.

The contents analyzing unit 270 detects the encrypted filter initial value information Sm(SR) Key and the correction information and extracts basic information such as filter size information used to recover the contents. The signal extraction unit 280 extracts the encrypted filter initial value information Sm(SR) Key and the correction information from the decompressed contents. The correction information extracted by the signal extraction unit 280 is transmitted to the contents correction unit 292. The encrypted filter initial value information Sm(SR) Key is transmitted to the initial value decryption unit 410. The distorted contents information (from which the encrypted filter initial value information Sm(SR) Key and the correction information are removed) is transmitted to the data filtering unit 291.

The initial value decryption unit 410 receives the encrypted filter initial value information Sm(SR) Key from the signal extraction unit 280 and decrypts the encrypted filter initial value information Sm(SR) Key. The decrypted filter initial value information is provided to the random number generation unit 294 and the inverse filter generation unit 420.

The random number generation unit 294 generates the filter information value (from the decrypted filter initial value information provided by the initial value decryption unit 410) which is used to recover the contents. The generated filter information value is transmitted to the inverse filter generation unit 420.

The inverse filter generation unit 420 generates the recovering filter for recovering the distorted contents based on the filter information value received from the random number generation unit 294 and the decrypted filter initial value information Sm(SR) Key received from the initial value decryption unit 410. The recovering filter generated by the inverse filter generation unit 420 has an inverse functional relation with the distorting filter used to distort the contents as described above.

The recovering filter information generated by the inverse filter generation unit 420 is transmitted to the data filtering unit 291. The data filtering unit 291 recovers the distorted contents based on the transmitted recovering filter information. More specifically, the data filtering unit 291 performs an inverse filtering process on the recovering filter transmitted from the inverse filter generation unit 420 to recover the distorted contents. Next, the data filtering unit 291 transmits the recovered contents to the contents correction unit 292.

The contents correction unit 292 corrects a portion of the recovered contents received from the data filtering unit 291 based on the correction information received from the signal extraction unit 280, so that more accurate received image can be obtained.

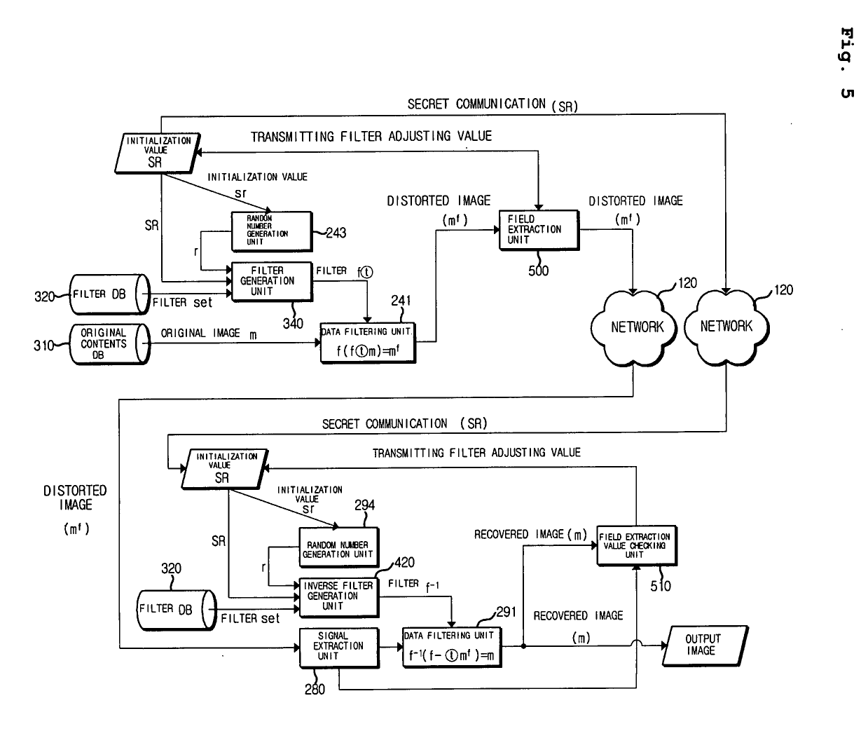

Now, a data flow in distorted contents generating and recovering apparatuses implement according to the aforementioned method will be described with reference to FIG. 5.

FIG. 5 is a view showing a data flow in distorted contents generating and recovering apparatuses according to an embodiment of the present invention.

Referring to FIG. 5, an original image m is stored in an original contents database 310; and the filter information is stored in a filter information database 320.

A plurality of filter sets are transmitted from the filter information database 320 to a filter generation unit 340. The filter generation unit 340 generates a filter f(t) based on the initial value SR and the random value r transmitted from a random number generation unit 243.

The original image m is provided to a data filtering unit 241. In the data filtering unit 241, the original image m is filtered by the filter f(t) generated by the filter generation unit 340. The filtered distorted image m^{f} can be represented by using the following Equation 1.
m^{f}=f(f\textcircled{t}m) [Equation 1]

The contents filtered by the data filtering unit 241 has a form of the filtered distorted image m^{f}. A field extraction unit 500 generates a field adjusting value based on the filtered distorted image m^{f}. The initial value SR is determined based on the field adjusting value generated by the field extraction unit 500. The initial value SR is provided to the filter generation unit 340 and the random number generation unit 243. The random number generation unit 243 generates the random number r based on the initial value SR. The random number r is provided to the filter generation unit 340.

The filter generation unit 340 generates the filter f(t) by using the initial value SR provided from the filter generation unit 340 and the random number r provided from the random number generation unit 243.

The filtered distorted image m^{f} is provided to clients via a network 120. The initial value SR is also provided to the clients via the network 120 by using secret communication.

In the clients, the filtered distorted image m^{f} is input to a signal extraction unit 280. After the signal extraction unit 280 extracts a signal of the filtered distorted image m^{f}, the filtered distorted image m^{f} is provided to a data filtering unit 291. The correction information transmitted together with the filtered distorted image m^{f} is provided to a field extraction value checking unit 510.

The data filtering unit 291 recovers the original image m by inverse-filtering the filtered distorted image m^{f}. The inverse-filtering process is performed by the inverse filter f⁻¹ which is received from the inverse filter generation unit 420.

The inverse filter generation unit 420 generates the inverse filter f⁻¹ based on the filter sets transmitted from the filter information database 320, the initial value SR transmitted from the initial value generation unit 210, and the random value r transmitted from the random number generation unit 294.

The initial value SR is a value provided from the transmitting party via network in a secret communication manner. The initial value SR is corrected based on the field adjusting value provided from the field extraction value checking unit 510. The random number generation unit 294 generates the random number r from the initial value SR and transmits the random number r to the inverse filter generation unit 420.

In the data filtering unit 291, a distorted image recovering process is performed by using the inverse filter f⁻¹ generated by the inverse filter generation unit 420. The distorted image recovering process performed by data filtering unit 291 can be represented by using the following Equation 2.
m=f⁻¹(f−\textcircled{t}m^{f}) [Equation 2]

The image m recovered by the data filtering unit 291 is corrected in order to obtain a completely recovered original image.

The corrected image is transmitted to the field extraction value checking unit 510. The field extraction value checking unit 510 generates the field adjusting value based on the recovered image and the correction information received from the signal extraction unit 280. The initialization value is adjusted based on the generated field adjusting value. Accordingly, the generated inverse filter f⁻¹ is corrected, so that more accurate image can be obtained.

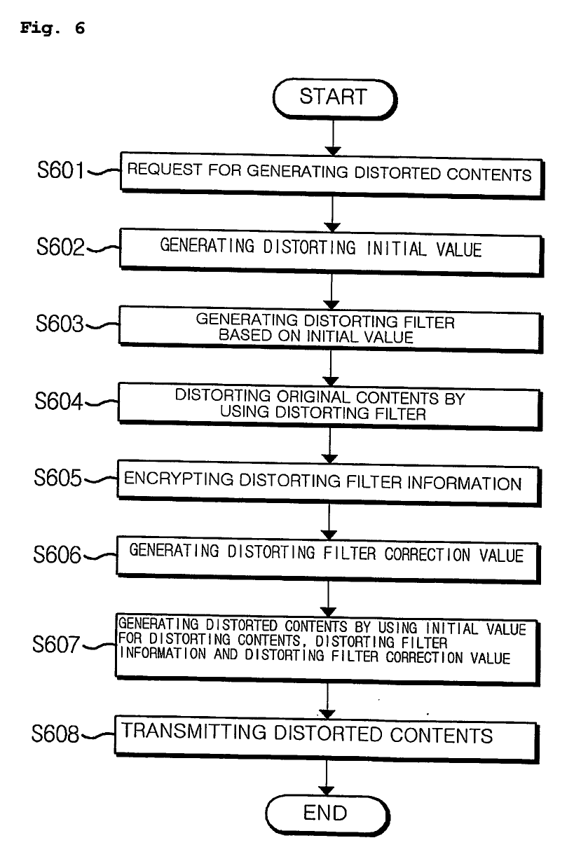

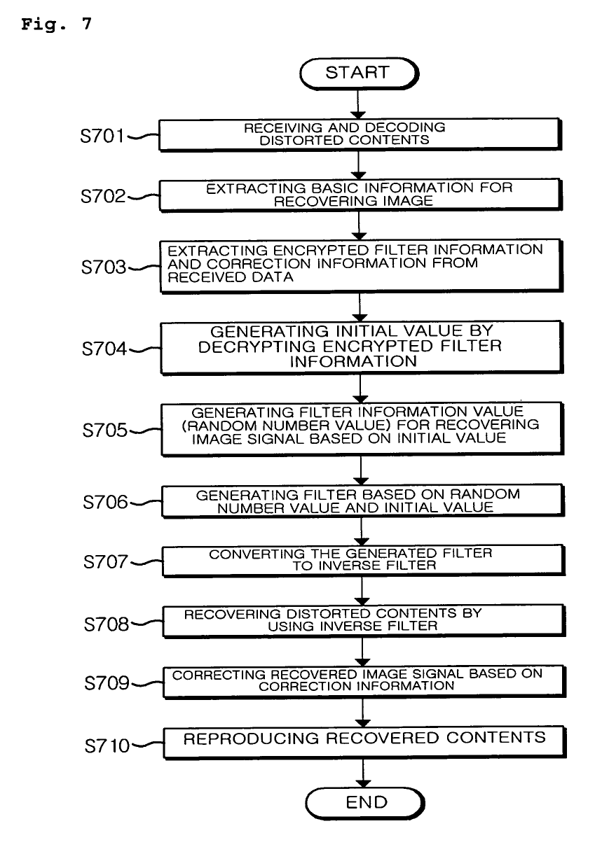

Now, distorted contents generating and recovering procedures will be described with reference to FIGS. 6 and 7.

FIG. 6 is a flowchart of a distorted contents generating procedure according to an embodiment of the present invention.

Referring to FIG. 6, when a distorted contents generating request is input (S601), a predetermined initial value used for generating a distorted contents is generated (S602).

Next, a distorting filter is generated based on the initial value (S603), and an original contents is distorted by the distorting filter (S604). Here, a predetermined random value is generated based on the initial value, and the distorting filter is generated based on the random value and the initial value.

After the original contents is distorted by the distorting filter, the information on the distorting filter, that is, the initial value information on the distorting filter, is encrypted (S605), and the correction information on the distorted contents is generated (S606).

Finally, the distorted contents, the distorting filter information (the initial value information on the distorting filter), and the distortion correction information are packaged to generate packaged distorted contents. The distorted contents, that is, the packaged distorted contents, is transmitted (S608).

FIG. 7 is a flowchart of a distorted contents recovering procedure according to an embodiment of the present invention.

Referring to FIG. 7, the client receives and decodes the distorted contents (S701). Basic information used to recover the distorted contents is extracted from the decoded distorted contents (S702). The encrypted filter information (that is, the encrypted filter initial value information) and the correction information are extracted from the received distorted contents.

Next, the extracted encrypted filter information is decrypted to generate the initialization value (S704). The filter information (that is, the random value) used to recover image signals is generated based on the initialization value (S705). The recovering filter is generated based on the random value and the initialization value (S706). The generated recovering filter is converted into an inverse filter (S707). The distorted image signal is recovered by the inverse filter (S708).

Finally, the recovered image signal is corrected based on the extracted correction information (S709), so that a more accurate image signal can be obtained. The recovered contents (that is, the image signal) is reproduced (S710).

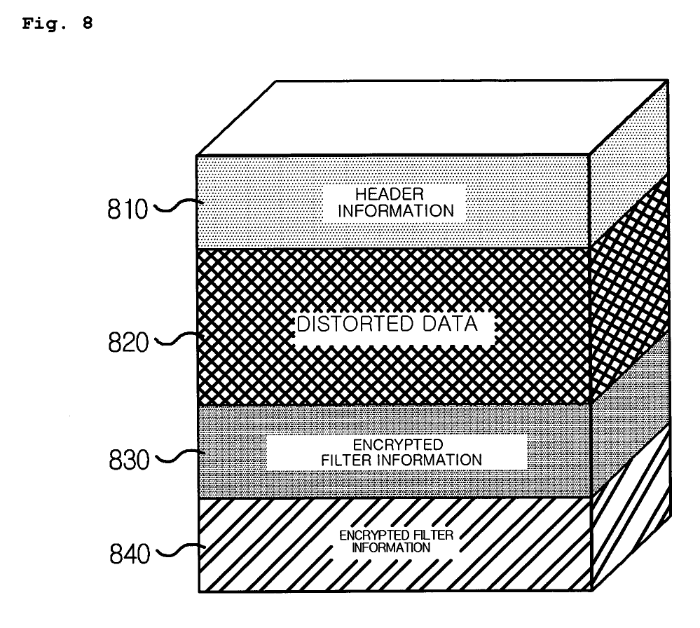

FIG. 8 is a view showing a structure of packaged distorted contents according to an embodiment of the present invention.

Referring to FIG. 8, the packaged distorted contents according to the present invention comprises header information 810, distorted data 820, encrypted filter information 830, and correction information 840. A contents provider transmits the distorted data 820, the encrypted filter information 830, and correction information 840 together with the distorted contents.

The header information 810 includes encoding header information which is inserted to the encoded contents in accordance with the compression scheme in the contents encoding process. The distorted data 820 is a portion of the contents distorted by the distorting filter according to the present invention.

The encrypted filter information 830 is information generated by encrypting the filter initial value information which is used to construct the recovering filter by the client. For example, 5 Kbytes can be allocated to the encrypted filter information 830. The client receiving the distorted contents decrypts the encrypted filter information 830 and constructs the recovering filter based on the decrypted initial value.

The correction information 840 is additional information used to obtain more accurate recovered contents by the recovering filter of the client. The image lost in the encoding or compressing process is corrected. For example, 10 Kbytes is allocated to the correction information 840.

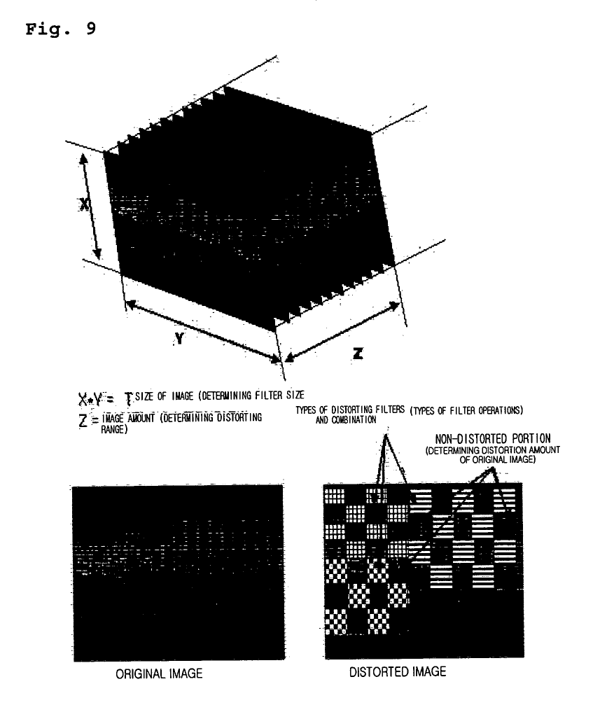

FIG. 9 is a view showing a method of distorting an original image according to an embodiment of the present invention.

Referring to FIG. 9, one moving picture contents can be distorted in units of a still image, that is, a frame by the distorting filter.

In the upper figure of FIG. 9, the size of still image is X*Y, where X and Y are lengths of X and Y axes. The image amount of a moving picture contents is represented by Z, which is a length of Z axis.

Therefore, the size of the distorting filter is determined according to the still image size X*Y, and the distorting range is determined according to the image amount Z. The information (that is, the still image size and the image amount) on the to-be-distorted image is determined by the data determination unit 220 of the distorted contents generating apparatus 110. The components of the distorted contents generating apparatus 110 are controlled based on the determined information.

In FIG. 9, the left figure shows the original image, and the right figure shows the distorted image filtered by the distorting filter. The distortion type is determined according to the types and combination (that is, the type of the filter operations) of the distorting filters. The distortion degree of the image is also determined by the distortion type.

The distortion amount of the original image is determined according to types of the distorting filter. According to the characteristics of the distorting filter, non-distorted portions of the image are generated. The recognition degree for the distorted contents depends on the amount of the non-distorted portions, that is, the distortion amount. By adjusting the distortion amount of the distorted image, attention of the client or user to the image can increase, so that a desire to see original image can increase. Therefore, the user or client is induced to purchase the charged contents.

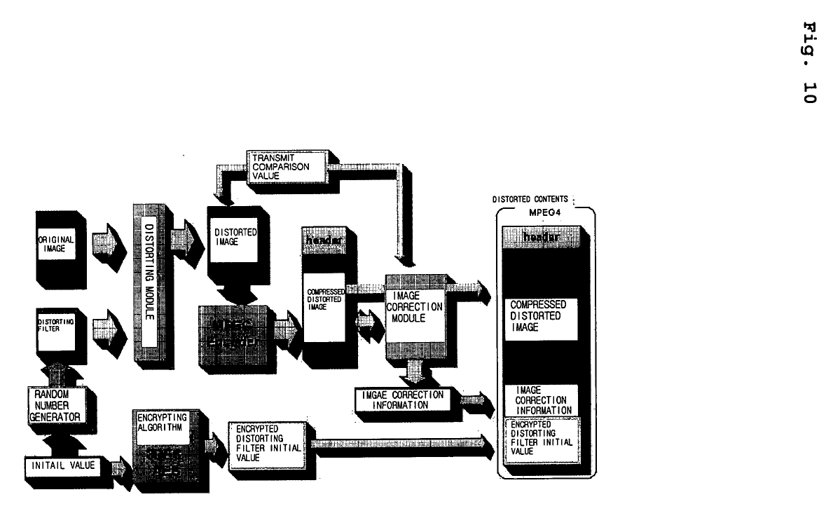

FIG. 10 is a view showing a distorted contents generating method according to an embodiment of the present invention.

Referring to FIG. 10, various kinds of data are added to the distorted contents according to the various original image distorting processes in order to protect the copyright to the original image.

The original image is distorted by a distorting module, and a predetermined header is inserted to the distorted contents by an image encoder such as an MPEG encoder to generate a compressed distorted image. The compressed distorted image is compared with the original image by an image correction module to generate a comparison value. Next, image correction information is generated based on the comparison value.

In addition, in a distorting module, an initial value used to generate the distorting filter is generated. In a random number generation unit, a random value is generated based on the initial value. Next, the distorting filter is generated based on the initial value and the random value. A distorting process is performed on the original image by the distorting filter of the distorting module. The initial value is encrypted according to a predetermined encrypting algorithm to generate an encrypted distorting filter initial value. The encrypted distorting filter initial value together with the image correction information is inserted into the compressed distorted image.

Therefore, the distorted contents may comprise the header, the compressed distorted contents, the image correction information, and the encrypted distorting filter initial value, as described above in FIG. 8.

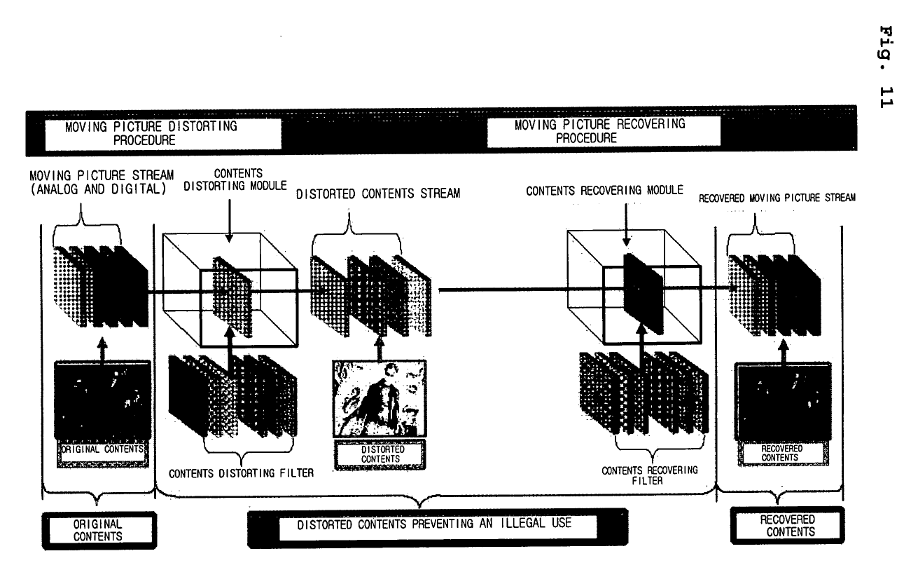

FIG. 11 is a view showing a distorted moving picture contents generating and recovering system according to the present invention.

Referring to FIG. 11, a moving picture contents as an original contents is distorted and recovered according to the present invention.

The original contents constructed with an analog or digital moving picture contents stream is distorted by the distorting module according to the present invention. The still images of the moving picture contents stream are filtered by the distorting filter, so that the distorted images are generated.

The distorted contents stream is transmitted to a receiving party (that is, a client or user). An unauthorized user or client cannot illegally use the distorted contents stream.

On the other hand, a user having an authorized contents recovering module can recover the distorted contents or image. The distorted moving picture contents stream can be provided to the authorized client.

Although the distorted contents copied by an illegal or unauthorized user may be somewhat recognized, the illegal or unauthorized user cannot accurately recognize the associated original contents. Therefore, attention of the client or user to the image can increase, so that a desire to see original image can increase. Therefore, the user or client is induced to purchase the charged contents.

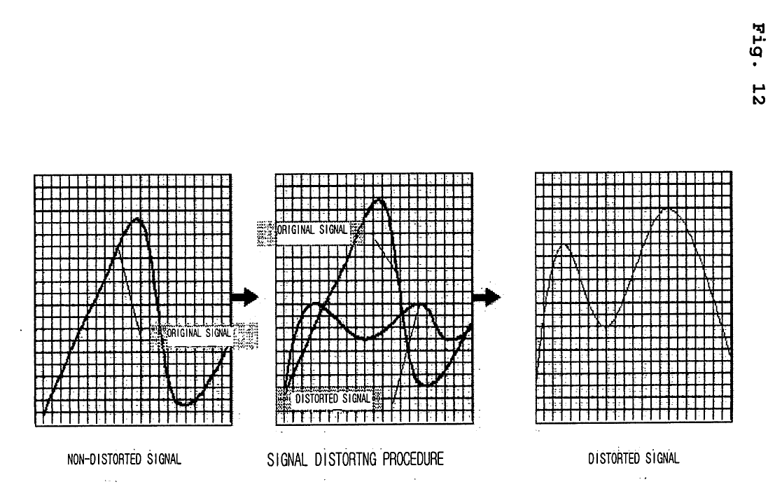

FIG. 12 is a view showing a distorted sound contents generating and recovering system according to the present invention; and

Referring to FIG. 12, a process for distorting an original data by using the distorting filter can be seen.

The non-distorted signal, that is, the original signal, is distorted by the filtering of the filter, and the distorted signal is output.

The distortion degree of the distorted signal depends on settings of the distorting filer. The distorting filter can be determined by using the initial value and the random value as described above. By adjusting the initialization value, the distortion degree of the distorted signal can change.

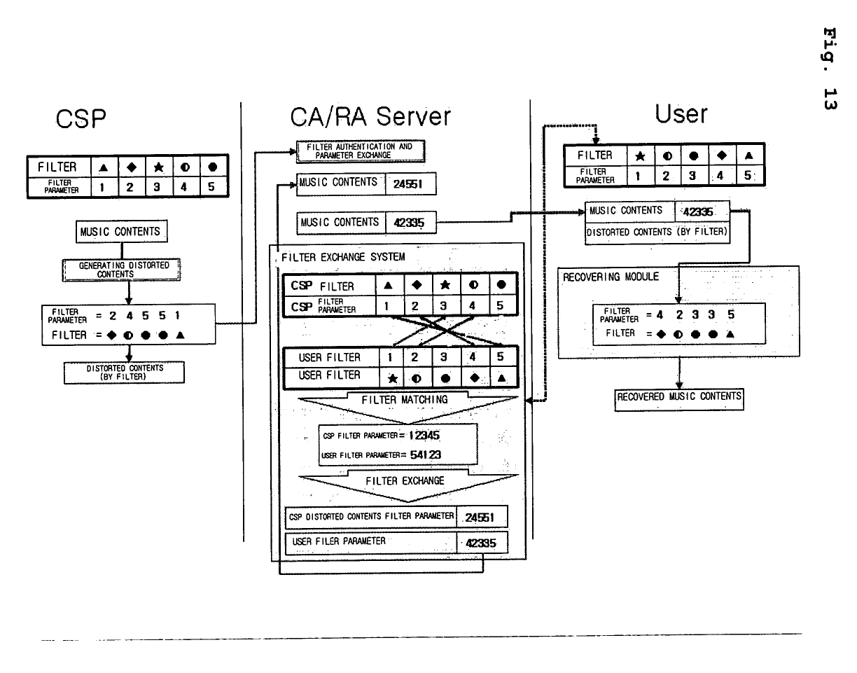

FIG. 13 is a view showing a recovering key exchange procedure used for the distorted sound contents generating and recovering system according to the present invention. Assuming that there are five filters 1, 2, 3, 4, and 5, a filter parameter {2, 4, 5, 5, 1} can be set by generating the initial value and the random number. A music sound is filtered by a filter corresponding to the filter parameter, so that the distorted music sound can be obtained.

In a CA/RA server, the filter parameter used by the distorting device is converted into another filter parameter {4, 2, 3, 3, 5} by the filter exchange system. The filter parameter {4, 2, 3, 3, 5} together with the distorted music sound contents is transmitted to the user. In the recovering module of the user performs the inverse filtering process on the distorted music sound contents based on the filter parameter and the filter matching information obtained from the filter parameter, so that an original contents can be reproduced.

While the present invention has been particularly shown and described with reference to exemplary embodiments thereof, it will be understood by those skilled in the art that various changes in form and details may be made therein without departing from the spirit and scope of the present invention as defined by the appended claims.

### INDUSTRIAL APPLICABILITY

According to the present invention, since a portion of a digital contents is distorted before the digital contents is distributed, it is possible to prevent the digital contents from illegally hacked and copied, so that it is possible to protect a copyright to the digital contents.

In addition, since a user can easily access the digital contents, the digital contents can be provided via various distribution paths without infringement of a copyright to the digital contents, so that it is possible to increase advertisement effect of the digital contents.

In addition, since the digital contents provided to the user can be partially recovered without au authentication process, the user previously sees and hears a portion of the digital contents, so that attention of the client or user to the digital contents can increase and a desire to see or hear original contents can increase. Therefore, the user or client is induced to purchase the charged contents.

In addition, the recovering filter data is gradually removed in the recovering procedure, it is possible to prevent the digital contents from being illegally copied and to limit the recovering and reproducing times.

In addition, unlike a conventional DRM scheme, according to a digital contents protection scheme of the present invention, the digital contents is distorted by a distorting filter in advance before it is distributed, and then the distorted contents is recovered by a recovering filter, so that the scheme can be applied to all types of digital contents devices including analog devices. Therefore, it is possible to reduce costs for protecting a copyright to the digital and analog contents.

In addition, the digital contents distorting and recovering method can be easily applied to public broadcasting contents. In addition, it is possible to reduce costs for implementing a CAS system (conditional access system).

1. A distorted contents generating apparatus comprising:
an initial value generation unit for generating an initial value used to generate a random number for a distorting filter;
a random number generation unit for generating a random number for the distorting based on the initial value transmitted from the initial value generation unit;
a filter generation unit for generating a distorting filter based on the random number;
a data filtering unit for distorting an original contents by filtering the original contents with the distorting filter;
an encoding unit for encoding the distorted contents output from the data filtering unit;
a signal insertion unit for encrypting the initial value information generated by the initial value generation unit and inserting the encrypted filter initial value into the distorted contents; and
an image correction unit for inserting image correction information into the encoded distorted contents transmitted from the encoding unit.

2. The distorted contents generating apparatus according to claim 1,
wherein the original contents is an analog signal, and
wherein the apparatus further comprises an analog-to-digital conversion unit for converting the analog signal to a digital signal and outputting the digital signal to the data filtering unit.

3. The distorted contents generating apparatus according to claim 1, further comprising:
a data determination unit for analyzing format information of the original contents; and
a configuration setting unit for determining a configuration setting value of the distorting filter based on the analyzed format information.

4. The distorted contents generating apparatus according to claim 1, wherein the data determination unit analyzes at least information of a screen size, the number of frames, a reproducing time, and a date amount per unit time of the original contents.

5. The distorted contents generating apparatus according to claim 1, wherein the configuration setting value determined by the configuration setting unit includes information on at least one of the number of partitions per frame of contents, the number of partitions to which the random number for the distorting filter is applied, an occupation rate of the random number for the distorting filter applied to the partitions of each of the frames of the contents, the number of distorting filters applied to streams of the digital contents, and a stream range to which the distorting filter is applied.

6. The distorted contents generating apparatus according to claim 1, further comprising an initial value encrypting unit for encrypting the initial value information generated by the initial value generation unit.

7. The distorted contents generating apparatus according to claim 1, further comprising a signal packaging unit for packaging and transmitting a plurality of image signals to which the image correction information and the encrypted filter initial value are inserted.

8. A distorted contents recovering apparatus comprising:
a decoding unit for decompressing and decoding a distorted contents;
a contents analyzing unit for extracting recovering information for the distorted contents;
a signal extraction unit for extracting an encrypted filter initial value and image correction information from the decompressed distorted contents; and
a contents recovering unit for generating a recovering filter based on the filter initial value and recovering contents from the distorted contents by using the recovering filter.

9. The distorted contents recovering apparatus according to claim 8, wherein a decoding scheme of the decoding unit is determined corresponding to an encoding scheme of an encoding unit of a distorted contents generating apparatus.

10. The distorted contents recovering apparatus according to claim 8, wherein the contents analyzing unit performs detecting the encrypted filter initial value information and the correction information.

11. The distorted contents recovering apparatus according to claim 8, wherein the contents recovering unit comprises:
a recovering filter generation unit for generating the recovering filter based on the encrypted filter initial value provided from the signal extraction unit;
a data filtering unit for filtering the distorted contents with the generated recovering filter; and
a contents correction unit for correcting a portion of the recovered contents based on the correction information transmitted from the signal extraction unit.

12. The distorted contents recovering apparatus according to claim 11, wherein the recovering filter generation unit comprises:
an initial value decryption unit for decrypting the encrypted filter initial value transmitted from the signal extraction unit;
a random number generation unit for generating an filter value information used to recover the contents based on the decrypted initial value transmitted from the initial value decryption unit; and
an inverse filter generation unit for generating the recovering filter used to recover the distorted contents based on the filter information value transmitted from the random number generation unit and the decrypted initial value transmitted from the initial value decryption unit.

13. A distorted contents generating method comprising steps of:
generating an initial value used to generate a random number for a distorting filter;
generating a distorting filter based on the generated initial value;
distorting an original contents with the distorting filter;
encrypting information on the distorting filter;
generating correction information on the distorted contents; and
generating the distorted contents by packaging the generated distorted contents, the information on the distorting filter, and the distortion correction information.

14. The distorted contents generating method according to claim 13, further comprising steps of:
generating a predetermined random value based on the generated initial value; and
generating a distorting filter based on the generated random value and the generated initial value.

15. The distorted contents generating method according to claim 13, further comprising a step of converting an analog contents signal to a digital contents signal.

16. The distorted contents generating method according to claim 13, further comprising:
a data determination step of analyzing format information of the original contents; and
a configuration setting step of determined a configuration setting value of the distorting filter based on the analyzed format information transmitted from the data determination step.

17. The distorted contents generating method according to claim 16, wherein the data determination step is performed by analyzing at least information of a screen size, the number of frames, a reproducing time, and a date amount per unit time of the original contents.

18. The distorted contents generating method according to claim 16, wherein the configuration setting value determined in the configuration setting step includes information on at least one of the number of partitions per frame of contents, the number of partitions to which the random number for the distorting filter is applied, an occupation rate of the random number for the distorting filter applied to the partitions of each of the frames of the contents, the number of distorting filters applied to streams of the digital contents, and a stream range to which the distorting filter is applied.

19. The distorted contents generating method according to claim 13, further comprising an initial value encrypting step of encrypting the initial value information generated by the initial value generation step.

20. The distorted contents generating method according to claim 13, further comprising a signal packaging step of packaging and transmitting a plurality of image signals to which the image correction information and the encrypted filter initial value are inserted.

21. A distorted contents recovering method comprising steps of:
receiving and decoding a distorted contents;
extracting encrypted filter information and correction information from the received distorted contents;
generating an initial value by decrypting the extracted encrypted filter information;
generating a filter information value used based on the generated initial value to recover an image signal;
generating a recovering filter based on the generated random value and the initial value;
recovering the distorted image signal by using the recovering filter; and
correcting the recovered image signal based on the extracted correction information.

22. The distorted contents recovering method according to claim 21, wherein a decoding scheme performed in the decoding step is determined corresponding to an encoding scheme performed in an encoding step of a distorted contents generating method.

23. The distorted contents recovering method according to claim 21, further comprising a contents analyzing step of extracting basic information from the decoded distorted contents used to recover the distorted contents.

24. The distorted contents recovering method according to claim 23, wherein the contents analyzing step further performs a step of detecting the encrypted filter initial value information and the correction information.

25. The distorted contents recovering method according to claim 21, wherein the contents recovering step comprises:
a recovering filter generation step of generating the recovering filter based on the encrypted filter initial value provided from the signal extraction step;
a data filtering step of filtering the distorted contents with the generated recovering filter; and
a contents correction step of correcting a portion of the recovered contents based on the correction information transmitted from the signal extraction step.

26. The distorted contents recovering method according to claim 25, wherein the recovering filter generation step comprises:
an initial value decrypting step of decrypting the encrypted filter initial value transmitted from the signal extraction step;
a random number generation step of generating an filter value information used to recover the contents based on the decrypted initial value transmitted from the initial value decrypting step; and
an inverse filter generation step of generating the recovering filter used to recover the distorted contents based on the filter information value transmitted from the random number generation step and the decrypted initial value transmitted from the initial value decrypting step.
